(19) United States
(12) Patent Application Publication
(10) Pub. No.: US 2026/0142436 A1
(43) Pub. Date: May 21, 2026

(54) High Power 193 Nanometer Continuous-Wave Laser Light

(71) Applicant: KLA Corporation, Milpitas, CA (US)

(72) Inventors: Xiaoxu Lu, Fremont, CA (US); Yung-Ho Alex Chuang, Cupertino, CA (US); John Fielden, Los Altos, CA (US)

(73) Assignee: KLA Corporation, Milpitas, CA (US)

(21) Appl. No.: 19/379,045

(22) Filed: Nov. 4, 2025

Related U.S. Application Data
(60) Provisional application No. 63/723,129, filed on Nov. 21, 2024.

(51) Int. Cl. H01S 3/109; G02F 1/35; G02F 1/355; H01S 3/00; H01S 3/081; H01S 3/16

(52) U.S. Cl. CPC H01S 3/109; G02F 1/354; G02F 1/3551; H01S 3/0092; H01S 3/081; H01S 3/1608; H01S 3/1611; H01S 3/1618; H01S 3/1643

(57) ABSTRACT

A laser assembly and a method for generating continuous-wave (CW) light at approximately 193 nm (between 180 nm and 200 nm) and at a power of 1W or higher using two CW laser sources: one laser source generating first fundamental light that is twice frequency doubled or otherwise converted into first CW light having a first deep-ultraviolet (DUV) wavelength between 250 nm and 275 nm, the other laser source generating second CW light having an infrared (IR) wavelength between 1300 nm and 1700 nm. A resonant cavity receives the second CW light and generates enhanced CW light at 100 W or higher. A first non-linear optical (NLO) crystal mixes a first enhanced CW light portion and the first CW light to generate sum-frequency generation (SFG) light having a second DUV wavelength. A second NLO crystal mixes a second enhanced CW light portion and the SFG light to generate output CW light at approximately 193 nm.

### RELATED APPLICATIONS/PATENTS

This application claims priority from U.S. Provisional Patent Application No. 63/723,129, entitled “A 193 nm CW Laser and a Method of Generating Laser Light”, which was filed on Nov. 21, 2024.

### FIELD OF THE INVENTION

The present invention relates to deep-ultraviolet (DUV) lasers and, more particularly, to a laser assembly capable of generating continuous wave (CW) light with a vacuum wavelength near 193 nanometers (193 nm) at a power level (e.g., 1 W or higher). This invention further relates to a method of generating high power 193 nm CW laser light, and to systems and methods using a high power 193 nm CW laser assembly to, for example, inspect and/or measure a photomask, reticle, semiconductor wafer or other substrate used in semiconductor or related manufacturing processes.

### BACKGROUND

As semiconductor devices' dimensions shrink, the size of the smallest particle or pattern defect that can cause a device to fail also shrinks. Hence, a need arises for detecting smaller particles and defects on patterned and unpatterned semiconductor wafers and reticles. The intensity of light scattered by particles smaller than the wavelength of that light generally scales as a high power of the dimensions of that particle (for example, the total scattered intensity of light from an isolated, small, spherical particle scales proportional to the sixth power of the diameter of the sphere and inversely proportional to the fourth power of the wavelength). Because of the increased intensity of the scattered light, shorter wavelengths will generally provide better sensitivity for detecting small particles and defects than longer wavelengths. Therefore, high speed inspection in the semiconductor industry is commonly performed in machines utilizing ultraviolet (UV) light. As the minimum size of particles and defects shrinks with successive semiconductor manufacturing nodes, a need arises for light sources with higher power and shorter wavelengths.

Wavelengths near 193 nm are of interest for several reasons. Light at a wavelength near 193 nm is used for semiconductor lithography and is therefore particularly useful for inspecting and measuring photomasks and reticles (i.e., because they are designed to operate at such wavelengths). Furthermore, because of the widespread use of light near this wavelength, optical elements, optical materials and optical coatings suitable for wavelengths near 193 nm are available from multiple suppliers, which may not be the case for other wavelengths shorter than 266 nm. Light much shorter in wavelength than 193 nm does not propagate through air as it is absorbed strongly (such as more than 50% attenuation within a propagation distance of about 1 m). Hence wavelengths near 193 nm are close to the shortest wavelength that can conveniently be used without most of, or the entire, light path being in a protected environment free of water, oxygen and other molecules that absorb short wavelength light.

CW lasers are preferred over pulsed lasers for inspection and measurement in the semiconductor industry for multiple reasons. CW lasers have narrower bandwidths than pulsed lasers. Narrower bandwidth simplifies the optical design of a system, especially high numerical-aperture (NA), large field-of-view objective lenses. Pulsed lasers have high peak power relative to the average power level. That peak power can damage materials including, potentially, optical elements and coatings within the system as well as the sample (such as a semiconductor wafer) being inspected or measured. Although optical designs exist for stretching laser pulses (and, hence, reducing their peak power), they further add cost and complexity to a system design. For a CW laser, peak power and average power are necessarily the same. Pulsed lasers have pulse-to-pulse variations in energy, which results in variability (noise) in the collected signal. This variability can reduce the sensitivity of the system by making it harder to detect small variations in signal caused by small particles and defects on the sample being inspected. Hence for these and other reasons, CW lasers are generally preferred in semiconductor inspection and metrology systems. However currently available CW lasers generating light near 193 nm in wavelength (referred to below as “prior-art 193 nm CW lasers”) are low power, limited to a few hundred milliwatts (mW) of power or less. Detecting very small particles and defects at high speed requires higher power levels, such as 1 Watt (1 W) or more.

What is needed is a laser apparatus and method that are capable of generating approximately 193 nm CW output light at output power levels greater than those achieved by existing (prior art) laser assemblies. What is particularly needed is cost-effective laser assembly and method that can produce stable (low noise) 193 nm CW laser light at output power levels of several hundred mWs to 1 W or higher. What is also needed is an inspection system that utilizes the laser apparatus.

### SUMMARY

The present invention is directed to a laser assembly and method for generating continuous-wave (CW) output light at approximately 193 nm (i.e., in a range between 180 nm and 200 nm) by generating first CW light at a first deep-ultraviolet (DUV) frequency having a first DUV wavelength in a range between 250 nm and 275 nm, generating second CW light at an infrared (IR) frequency having an IR wavelength in a range between 1300 nm and 1700 nm, utilizing one or more resonant cavities to enhance (increase the power of) the second CW light, and then performing two sum-frequency generation (mixing) operations using the first CW light and the enhanced CW light to generate the CW output light (i.e., mixing the first CW light with a first portion of the enhanced CW light to generate sum-frequency generation (SFG) light, and then mixing the SFG light with a second portion of the enhanced CW light to generate the CW output light). The present invention provides several advantages over existing prior-art 193 nm CW lasers that are currently utilized for high-speed inspection in the semiconductor industry. For example, as set forth in detail below, laser light sources capable of producing CW laser light at the required frequencies and power levels may be implemented using commercially available fundamental lasers and components, thereby enabling the cost-effective production of 193 nm CW laser assemblies implementing the present invention (i.e., by avoiding the need for specialized laser light sources and/or other specialized components). Furthermore, 193 nm CW laser assemblies produced in accordance with the present invention are more stable with lower noise than prior-art 193 nm CW lasers because, among other reasons, the assembly only uses resonant cavity/cavities that resonate at IR wavelengths (i.e. wavelengths longer than about 1 μm), and, hence, are not as sensitive to external disturbances (e.g., vibration and air turbulence) as cavities resonant at shorter (e.g., DUV) wavelengths. Moreover, the present invention facilitates the generation of 193 nm CW output light at an output power level of 1 W or higher without decreasing stability, thereby enabling the detection of smaller particles and defects than those detectable by prior-art 193 nm lasers.

In an embodiment, a laser assembly includes a first laser light source, a second laser light source and a sum-frequency generation (SFG) unit. The first laser light source is configured to generate first continuous-wave (CW) light at a first DUV frequency having a corresponding DUV wavelength in a range between 250 nm and 275 nm and at a first power level. The second laser light source is configured to generate second CW light at an infrared (IR) frequency having a corresponding IR wavelength in a range between 1300 nm and 1700 nm and at a second power level. The SFG unit includes at least one resonant cavity and at least two (first and second) non-linear optical (NLO) crystals. In some embodiments, each of the one or more resonant cavities is implemented by reflectors (e.g., flat and/or curved mirrors) arranged in a bowtie cavity, a delta-shaped (i.e., triangular) cavity or a standing-wave cavity. The resonant cavity/cavities is/are configured to receive and circulate the second CW light from the second laser light source (i.e., each resonant cavity is configured to resonate at the IR frequency of the second CW light) such that each resonant cavity generates enhanced (intensified) CW light having the same IR frequency of the unenhanced second CW light, but at an enhanced (third) power level (e.g., hundreds of watts or more) that is substantially higher than the second power level of the unenhanced second CW light. In some embodiments, both NLO crystals are implemented using a CLBO crystal, an LBO crystal or a BBO crystal. The first non-linear optical (NLO) crystal is positioned to receive the first CW light from the first laser light source and a first portion of the enhanced CW light from the one or more resonant cavities, and is configured to generate first SFG light at a second DUV frequency by mixing the first CW light and the first enhanced CW light portion (i.e., such that a second DUV wavelength of the first SFG light is between 193 nm and the first DUV wavelength of the first CW light). The second NLO crystal is positioned to receive the first SFG light leaving the first NLO crystal and a second portion of the enhanced CW light from the one or more resonant cavities, and is configured to generate CW output (second SFG) light having a third DUV frequency and a corresponding output wavelength of approximately 193 nm by mixing the first SFG light and the second enhanced CW light portion. By utilizing one or more resonant cavities to enhance the second CW light provided to both the first and second NLO crystals, the SFG unit provides two highly-efficient frequency conversion stages that facilitate the stable output of CW output light at power levels in a range from hundreds of mW to a few W or more. Moreover, the output power level of the CW output light may be selectively adjustable (e.g., by adjusting the power levels of the first and second CW light generated by the first and second laser light sources) between a relatively low-power level (e.g., hundreds of mW), which increases the operating life of the laser assembly, and a relatively high-power level (1 W or more) to enhance the laser assembly's ability to detection very small particles and defects.

In some embodiments, the first laser light source includes a first fundamental laser configured to generate first fundamental CW light at a first fundamental frequency having a corresponding first fundamental wavelength in a range between about 1010 nm and 1090 nm and a fourth harmonic generation module configured to generate the first CW light at a fourth harmonic of the first fundamental frequency, and the second laser light source includes a second fundamental laser configured to generate the second CW light at a second fundamental wavelength corresponding to the required IR wavelength range between 1300 nm and 1700 nm. Fundamental lasers capable of generating the first fundamental CW light (e.g., an Yb:YAG laser, a Nd:YAG laser, a Nd:YVO₄ laser, an ytterbium-doped fiber laser, or a Nd:YLF laser) and the second fundamental CW light (e.g., an Er:YAG laser, an erbium-doped fiber laser, a Nd:YVO₄ laser, or a Raman fiber laser) are currently commercially available at reasonable prices. Fundamental lasers of these types may be selectively matched using known techniques such that, when their respective fundamental frequencies are subsequently mixed by the SFG unit, CW output light is generated at a desired target wavelength. In an exemplary embodiment, the first fundamental laser is implemented using a Yb:YAG lasing medium capable of generating first fundamental CW light having a corresponding first fundamental wavelength of approximately 1029 nm, and the second fundamental laser is implemented using an erbium-doped fiber lasing medium configured to generate second CW light having a wavelength of approximately 1557 nm, whereby the SFG unit generates CW output light having a wavelength of 193.4 nm. In another exemplary embodiment, the first fundamental laser is implemented using an ytterbium-doped fiber lasing medium capable of generating first fundamental CW light having a corresponding first fundamental wavelength of approximately 1087 nm, and the second fundamental laser is implemented using a Nd:YVO₄ lasing medium configured to generate second CW light having a wavelength of approximately 1342 nm, whereby the SFG unit generates CW output light having a wavelength of 193.4 nm. Various combinations of fundamental wavelengths and frequency-conversion stages are disclosed herein, each of which may be configured to generate high power (e.g., about 1 W or more) CW laser light at a wavelength near 193 nm.

In some embodiments the sum-frequency generation (SFG) unit includes a beam splitter and two (first and second) resonant cavities respectively disposed in corresponding (first and second) sum-frequency generation modules. The beam splitter functions to split the second fundamental (second CW) light generated by the second fundamental laser into two CW portions that are respectively directed to the two sum-frequency generation (SFG) modules. The first SFG module includes the first resonant cavity and the first NLO crystal, and the second SFG module includes the second resonant cavity and the second NLO crystal. The first resonant cavity receives one of the two CW (second fundamental light) portions and the fourth harmonic (first CW) light. The resonant cavity includes multiple mirrors that collectively circulate the received CW portion in a resonant (e.g., standing wave, bowtie or delta-shaped) optical cavity to generate the first enhanced CW light portion and direct a first beam segment (i.e., a portion of the first enhanced CW light portion) through the first NLO crystal. The fourth harmonic (first CW) light is directed into the first NLO crystal such that it mixes with the first enhanced CW light portion to generate first SFG light. In some embodiments the first NLO crystal is configured such that both its input surface and its output surface are approximately at Brewster's angle relative to polarization of the incoming first beam segment of the first enhanced CW light portion to minimize reflection, and the first CW (fourth harmonic) light is directed onto the input surface at a slightly deviated angle (for example, an angle less than approximately 10° or an angle between about 2° and 7°) relative to the incoming enhanced CW light portion to ensure that the first CW light is substantially overlapped with the enhanced CW light portion inside the first NLO crystal (e.g., so that the first CW light is overlapped with the enhanced CW light over a distance equal to or greater than half of a length of the first NLO crystal in a light propagation direction). A further advantage of directing the first CW light at the slightly deviated angle is that this facilitates positioning cavity mirrors to circulate the enhanced CW light without causing interference with the incoming fourth harmonic light and the outgoing unconsumed first CW light and SFG light. The second resonant cavity is configured similarly to the first resonant cavity to receive the other second fundamental portion and to generate and circulate associated (second) enhanced CW light portion along a (second) optical path. The second NLO crystal is positioned along a segment of the second optical path such that a second beam segment of the second enhanced CW light portion is directed into the second NLO crystal and is also positioned to receive the SFG light from the first resonant cavity, whereby the (second) enhanced CW light portion mixes with the SFG light to generate the CW output light at approximately 193 nm (i.e., the third DUV frequency). In some embodiments the first SFG light is directed at a second deviated angle relative to the incoming enhanced CW light beam segment such that the first SFG light and the (second) enhanced CW light portion substantially overlap inside the second NLO crystal while avoiding interference with the incoming SFG light by the cavity mirrors and increasing the separation of the outgoing unconsumed SFG light and the CW output light. In this embodiment, an advantage of having two separate enhancement cavities is that those cavities may be aligned and optimized individually, thereby simplifying the optical alignment process. A further advantage is that the two cavities are independent of each other during operation, whereby if one of the NLO crystals degrades over time, its degradation only affects the cavity in which it operates and its corresponding sum frequency generation step and does not affect the enhanced second fundamental CW light circulating in the other cavity.

In some embodiments the laser assembly utilizes enhanced CW light generated by a single resonant cavity to perform the two sum-frequency generation (mixing) operations mentioned above. In these embodiments all of the second CW light generated by the second CW laser light source is directed into the single resonant cavity, and the two NLO crystals are located in respective different positions along the closed optical path formed by a first set of optical elements (e.g., mirrors and/or prisms; i.e., such that the two NLO crystals are positioned at different locations along the optical path and receive respective portions of the circulated enhanced CW light). In some embodiments the two NLO crystals are positioned between corresponding pairs of the optical elements forming the closed optical path (e.g., such that a (first) enhanced CW light portion comprises a first beam segment that is directed from a first mirror to an input surface of the first NLO crystal and unconsumed (first) enhanced CW light is directed from an output surface of the first NLO crystal to a second mirror, and such that a (second) enhanced CW light portion comprises a second beam segment that is directed from a third mirror to an input surface of the second NLO crystal and unconsumed (second) enhanced CW light is directed from an output surface of the second NLO crystal to a fourth mirror). In this case, the input and output surfaces of the first NLO crystal are configured approximately at Brewster's angle relative to polarization of the incoming enhanced CW light portion and the incoming first CW light is directed onto the input surface at a deviated angle for reasons similar to those explained above, where the deviated angle is carefully chosen such that the first DUV light (fourth harmonic light) and the enhanced fundamental light overlap well inside the first NLO crystal. In addition, a second set of optical elements (e.g., mirrors and/or prisms) are provided to direct the SFG light from the first NLO crystal to the second NLO crystal such that the SFG light is directed onto the input surface of the second NLO crystal at a second deviated angle for reasons similar to those explained above, where the second deviated angle is tuned so that the first CW light overlaps well with the second fundamental light inside the second NLO crystal. In some embodiments dichroic coating or prisms could be added so that the cavity mirrors do not reflect DUV wavelengths. In some embodiments lenses and/or other optical elements are positioned in the various optical paths to focus beam waists of the first CW light, the second CW light and the SFG light inside the two NLO crystals. In this embodiment, the two sum frequency generation steps happen in the same cavity. Using a single cavity saves cost (because of fewer components) and reduces the overall size of the laser assembly. Furthermore, this embodiment makes more efficient use of the second fundamental light by directing all that light to one cavity (i.e., rather than splitting it into two portions), which may reduce the power needed for the second fundamental laser and, hence, allow a less expensive second fundamental laser to be used compared with embodiments with two separate cavities. The power of the enhanced second fundamental in a single cavity can be significantly higher than the power in each of the two separate cavities, even with a similar or lower power second fundamental laser, and as a result both sum frequency generation steps can achieve higher conversion efficiency compared with two separate cavities. Having the two frequency-summing crystals separated from one another enables the use of Brewster cut crystals. In other embodiments the two NLO crystals are arranged in series in the closed optical path formed by the single resonant cavity (i.e., such that the SFG light exiting the first NLO crystal is directly received at the input surface of the second NLO crystal) and the various beams are directed in parallel and normal to the crystals' input and output surfaces. Using a single cavity for the 2^{nd} fundamental makes more efficient use of the second fundamental light and may reduce power requirements and, hence, reduce laser assembly production costs by facilitating the use of a less expensive second fundamental laser (i.e., in comparison with embodiments utilizing two separate cavities resonant at the second fundamental wavelength). In addition, having the two frequency-summing crystals close to another reduces the number of optical components and the complexity of the cavity.

In another embodiment an inspection system utilizes a CW laser assembly according to the present invention to inspect or make measurements on a sample using 193 nm CW laser light. The CW laser assembly may be incorporated into an illumination source configured such that the CW laser light is directed by way of suitable (first) optics to the sample, and light collect light from the sample (i.e., light that is either reflected by, scattered from, or transmitted through the sample) is directed by way of suitable (second) optics to a sensor/detector capable of converting the collected light into a corresponding electronic (e.g., digital) signal that can be analyzed by a suitably configured computer system to determine the presence or absence of a defect on the sample. In other embodiments, the inspection system may utilize the 193 nm CW output light and system components to perform other functions, such as to inspect and/or make measurements on a sample, to cut, drill or ablate material from a sample, or to expose a pattern in a photoresist layer formed on a sample. In each of these instances, the CW laser assembly significantly enhances the capabilities of the inspection system by facilitating the generation of 193 nm CW output light with a power of 1 W or higher.

It is to be understood that both the foregoing general description and the following detailed description are exemplary and explanatory only and are not necessarily restrictive of the invention as claimed. Although specific output wavelengths, such as 193 nm and 193.4 nm, are mentioned in this disclosure, the principles described herein are applicable with simple modifications readily understood by those skilled in the relevant arts to generate other nearby DUV wavelengths, such as a wavelength in a range between about 180 nm and 200 nm. Furthermore, it will be understood that the light described herein as output light having a wavelength of about 193 nm might be light generated in an intermediate step towards generating light having a wavelength shorter than 180 nm using at least one additional frequency-conversion stage, wherein the output light having a wavelength of about 193 nm is an input to the at-least-one additional frequency-conversion stage. The accompanying drawings, which are incorporated in and constitute a part of the specification, illustrate embodiments of the invention and together with the general description, serve to explain the principles of the invention.

### BRIEF DESCRIPTION OF THE DRAWINGS

The numerous advantages of the invention may be better understood by those skilled in the art by reference to the accompanying figures in which:

FIG. 1 is a block diagram showing a simplified exemplary CW laser assembly according to an embodiment of the invention;

FIGS. 2A and 2B are simplified block diagrams showing exemplary CW laser assemblies configured to generate light having a wavelength near 193 nm in accordance with corresponding embodiments of the invention;

FIG. 2C shows a table of exemplary fundamental wavelengths that may be used within the laser assemblies of FIGS. 2A and 2B to generate light having a wavelength near 193 nm, in accordance with one or more embodiments of the invention;

FIG. 3A is simplified diagram showing a sum-frequency generation module utilized in the CW laser assembly of FIG. 2A in accordance with an exemplary embodiment of the invention;

FIG. 3B is a simplified diagram showing a sum-frequency generation module utilized in the CW laser assembly of FIG. 2A in accordance with an exemplary embodiment of the invention; and

FIG. 4 is a simplified diagram showing a sum-frequency generation unit utilized in the CW laser assembly of FIG. 2B in accordance with an exemplary embodiment of the invention;

FIG. 5 is a simplified diagram showing a sum-frequency generation unit utilized in the CW laser assembly of FIG. 2B in accordance with another exemplary embodiment of the invention; and

FIG. 6 is a simplified block diagram showing an exemplary inspection or metrology system according to another embodiment of the invention.

### DETAILED DESCRIPTION

The present invention generally relates to laser assemblies capable of generating CW laser light having a wavelength near 193 nm that are suitable for use in semiconductor inspection systems and other applications. The following description is presented to enable one of ordinary skill in the art to make and use the invention as provided in the context of a particular application and its requirements. As used herein, directional terms such as “top”, “left” and “right” are intended to provide relative positions for purposes of description and are not intended to designate an absolute frame of reference. As used herein, the term “segment” refers to a straight-line section of an optical path located between two optical elements (e.g., a portion of the optical path extending between two mirrors or between a mirror and an NLO crystal) and the phrase “beam segment” is used to identify a laser light portion directed along an optical path segment (e.g., the portion of enhanced CW light reflected from one mirror to a second mirror along the optical path). Various modifications to the described embodiments will be apparent to those with skill in the art and the general principles defined herein may be applied to other embodiments. Therefore, the present invention is not intended to be limited to the particular embodiments shown and described but is to be accorded the widest scope consistent with the principles and novel features herein disclosed.

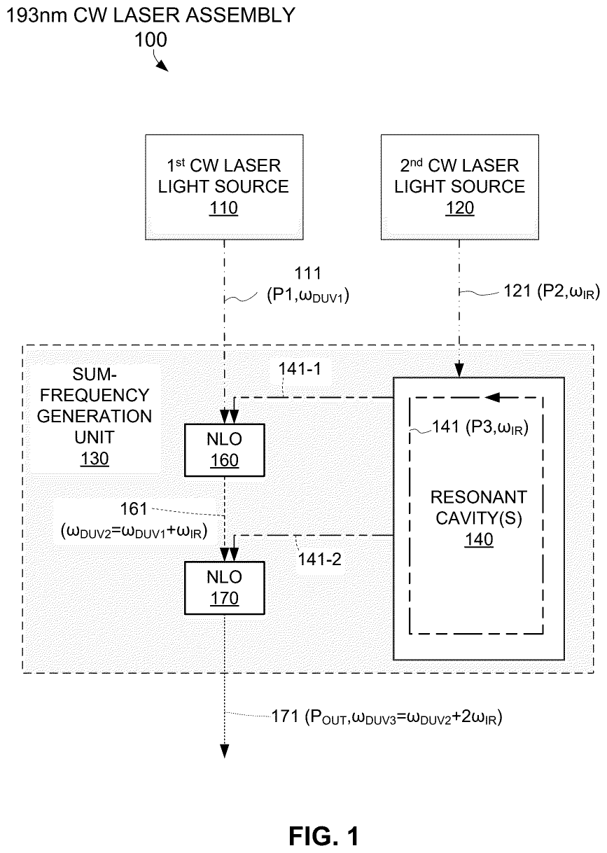

FIG. 1 shows a laser assembly 100 according to a generalized embodiment of the invention. Laser assembly 100 includes a first laser light source 110, a second laser light source 120 and a sum-frequency generation (SFG) unit 130 that are configured as set forth below to generate CW output light 171 at a (third) DUV frequency ω_{DUV3} having a corresponding target output wavelength of approximately 193 nm (i.e., in a range between 180 nm and 200 nm). First laser light source 110 is configured to generate first CW light 111 at a first power level P1 and at a first DUV frequency ω_{DUV1} (i.e., such that first CW light 111 has a first DUV wavelength in a range between 250 nm and 275 nm). Second laser light source 120 is configured to generate second CW light 121 at a second power level P2 and at an IR frequency ω_{IR} (i.e., such that second CW light 121 has an IR wavelength in a range between 1300 nm and 1700 nm). In an embodiment the first DUV frequency of first CW light 111 and the IR frequency of second CW light 121 are selected (matched) such that, when mixed in the manner described below, CW output light 171 may be generated with an output (third DUV) wavelength equal to 193.4 nm. SFG unit 130 includes at least one resonant cavity 140, a first non-linear optical (NLO) crystal 160 and a second NLO crystal 170. Resonant cavity 140 is positioned to receive second CW light 121 from second laser light source 120 and configured to resonate at IR frequency ω_{IR}, whereby resonant cavity 140 generates enhanced (intensified) second CW light 141 having the same IR frequency ω_{IR} of second CW light 121, but having an enhanced (third) power level P3 (e.g., 100 W or more) that is substantially higher than second power level P2 of second CW light 121. First NLO crystal 160 is positioned to receive first CW light 111 from first laser light source 110 (e.g., by way of a suitable optical path) and a first portion 141-1 of enhanced CW light 141 from resonant cavity 140, and first NLO crystal 160 is configured to generate (first) SFG light 161 at a second DUV frequency ω_{DUV2} by mixing (performing sum-frequency generation of) the received first CW light 111 and first portion 141-1 of enhanced CW light 141, whereby SFG light 161 has a DUV wavelength that is between the target output (third DUV) wavelength (i.e., approximately 193 nm) and the DUV wavelength of first CW light 111. Second NLO crystal 170 is positioned to receive first SFG light 161 from first NLO crystal 160 and is configured to generate CW output (second SFG) light 171 at an output (third DUV) frequency ω_{DUV3} having the target output (third DUV) wavelength of approximately 193 nm by mixing the first SFG light 161 and a second portion 141-2 of the enhanced CW light 141 received from resonant cavity 140.

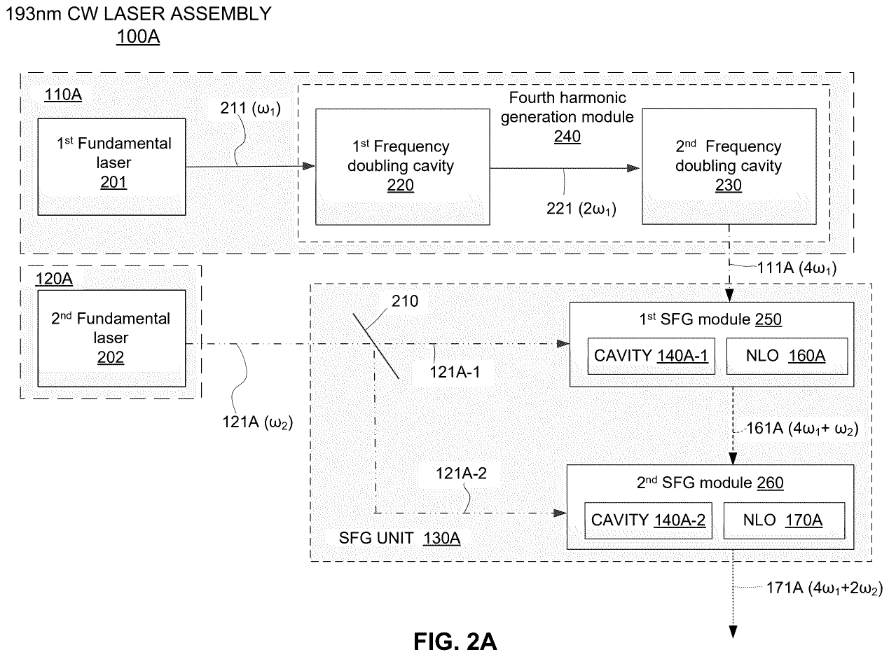

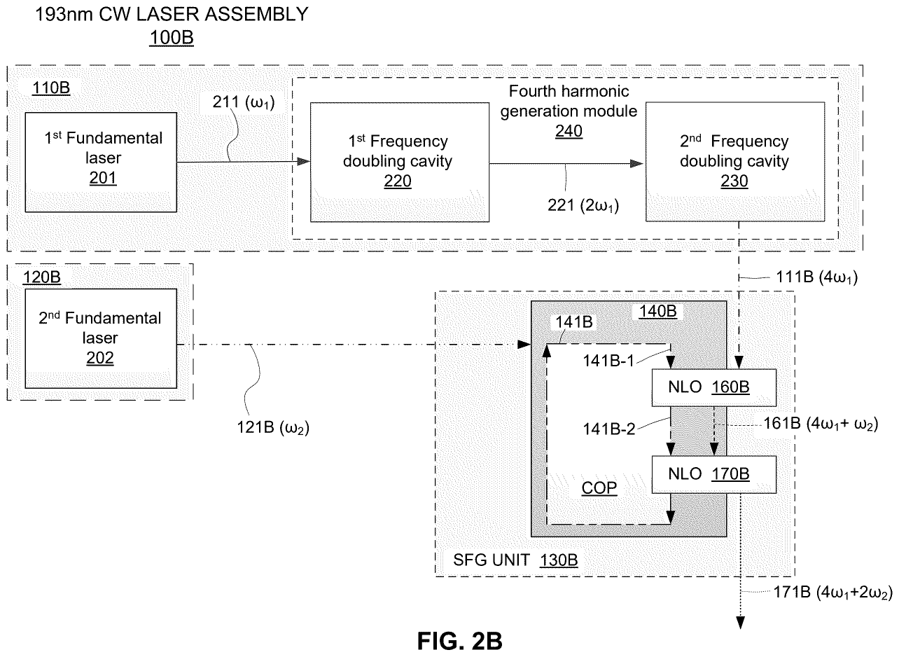

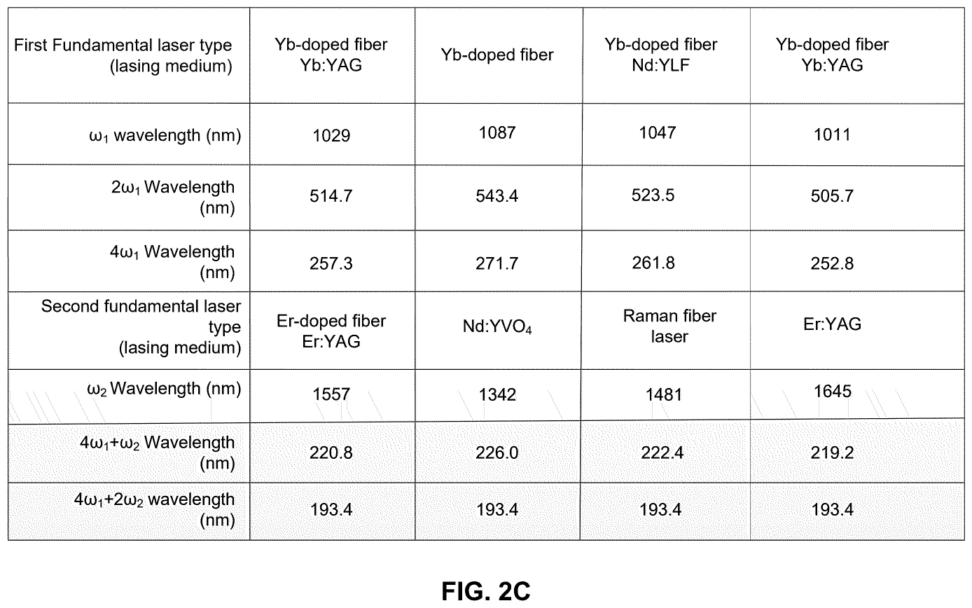

FIGS. 2A and 2B are simplified block diagrams respectively showing exemplary CW laser assemblies 100A and 100B according to two exemplary embodiments of the present invention. CW laser assembly 100A (FIG. 2A) includes a first laser light source 110A, a second laser light source 120A, and a sum-frequency generation (SFG) unit 130A including a pair of resonant cavities 140A-1 and 140A-2, a first NLO crystal 160A and a second NLO crystal 170A. CW laser assembly 100B (FIG. 2B) includes a first laser light source 110B, a second laser light source 120B, and a SFG unit 130B including a single resonant cavity 140B, a first NLO crystal 160B and a second NLO crystal 170B.

CW laser assemblies 100A and 100B are similar in that both first laser light source 110A (FIG. 2A) and first laser light source 110B (FIG. 2B) include a first fundamental laser 201 and a fourth harmonic generation module 240, and both second laser light source 120A (FIG. 2A) and second laser light source 120B (FIG. 2B) include a second fundamental laser 202. Note that certain core components are identified by the same reference numbers in each of FIGS. 2A and 2B to indicate that these core components are configured and function in substantially similar manners in each of the two exemplary embodiments. Specifically, referring to first laser light source 110A (FIG. 2A) and first laser light source 110B (FIG. 2B), first fundamental laser 201 is configured using known techniques to generate fundamental light 211 (often referred to simply as the “fundamental” in the industry) at a first fundamental frequency ω₁ having a first fundamental wavelength corresponding to an infra-red wavelength in the range of approximately 1010 nm to approximately 1090 nm. Fourth harmonic generation module 240 comprises two frequency doubling cavities: first frequency doubling cavity 220, and second frequency doubling cavity 230. First frequency doubling cavity 220 receives the first fundamental light 211 and generates second harmonic light 221 at a second harmonic frequency 2ω₁ equal to twice the first fundamental frequency ω₁. The second frequency doubling cavity 230 receives the second harmonic light 221 and generates first CW light 111A (FIG. 2A) or first CW light 111B (FIG. 2B) at a fourth harmonic frequency 4ω₁ equal to four times the first fundamental frequency ω₁ (i.e., at a fourth harmonic of first fundamental frequency ω₁). Similarly, referring to second laser light source 120A (FIG. 2A) and second laser light source 120B (FIG. 2B), second fundamental laser 202 is configured to generate second CW light 121A (FIG. 2A) or second CW light 121B (FIG. 2B) at a second fundamental frequency ω₂ having a second fundamental wavelength corresponding to an infra-red wavelength in the range between approximately 1300 nm to approximately 1700 nm.

In some embodiments both first fundamental CW laser 201 and second fundamental layer 202 are implemented using commercially available fundamental CW lasers. In an exemplary embodiment, first fundamental laser 201 may be implemented using one of an ytterbium-doped yttrium aluminum garnet (Yb:YAG) lasing medium, a neodymium-doped yttrium aluminum garnet (Nd:YAG) lasing medium, a neodymium-doped yttrium orthovanadate (Nd:YVO₄) lasing medium, and an ytterbium-doped fiber lasing medium, and second fundamental laser may be implemented using one of an erbium-doped yttrium aluminum garnet (Er:YAG) lasing medium, an erbium-doped fiber lasing medium, a neodymium-doped yttrium orthovanadate (Nd:YVO₄) lasing medium, and a Raman fiber lasing medium. Suitable fundamental CW lasers of the types listed above are commercially available from Coherent Corp. of Saxonburg, Pennsylvania, USA, IPG Photonics Corp. of Marlborough, Massachusetts, USA, and/or other manufacturers. Laser power levels for such CW fundamental lasers can range from milliwatts to one hundred Watts or more. In an alternate exemplary embodiment, first fundamental laser 201 is implemented by a laser using a Nd:YLF (neodymium-doped yttrium lithium fluoride) lasing medium that generates fundamental laser light at a fundamental wavelength near 1053 nm or 1047 nm. In yet another exemplary embodiment, first fundamental laser 201 can be implemented using a Yb:YAG (ytterbium-doped yttrium aluminum garnet) lasing medium or by an ytterbium-doped fiber lasing medium that generates fundamental laser light at a fundamental wavelength near 1029 nm.

Each frequency doubling cavity 220 and 230 comprises an external resonant cavity including at least three optical mirrors and a nonlinear crystal arranged therein. The cavities can be stabilized with standard Pound-Drever-Hall (PDH) or Hänsch-Couillaud (HC) locking techniques. The cavity length is adjusted to maintain resonance by adjusting the position of a mirror or prism through a control signal. In a preferred embodiment, first frequency doubling cavity 220 that generates the second harmonic light 221 can include a lithium triborate (LBO) crystal, which can be substantially non-critically phase-matched (for the appropriate choice of crystal plane) at temperatures between room temperature and about 200° C. for producing second harmonic light 221 in a wavelength range between about 505 nm and about 545 nm. In alternative embodiments, first frequency doubling cavity 220 may include a cesium lithium borate (CLBO) crystal or a beta-barium borate (BBO) crystal, either of which can be critically phase-matched for generating a second harmonic in a wavelength range between about 505 nm and about 545 nm. In yet other embodiments, first frequency doubling cavity 220 may include a KTiOPO₄ (KTP), periodically poled lithium niobate (PPLN) crystal, or other nonlinear crystal for frequency conversion. Second frequency doubling cavity 230 that generates the fourth harmonic (first CW) light may use critical phase matching in CLBO, BBO or other non-linear crystal. In preferred embodiments, second frequency doubling cavity 230 comprises a hydrogen-treated or deuterium-treated CLBO crystal. In an alternate embodiment (not shown), first frequency doubling cavity 220 may be combined with fundamental laser 201 to use the intra-cavity frequency doubling with a nonlinear optical (NLO) crystal placed inside the fundamental solid state laser cavity. This alternate embodiment uses an external resonant cavity similar to second frequency doubling cavity 230 to generate fourth harmonic (first CW) light 111A in the manner described above.

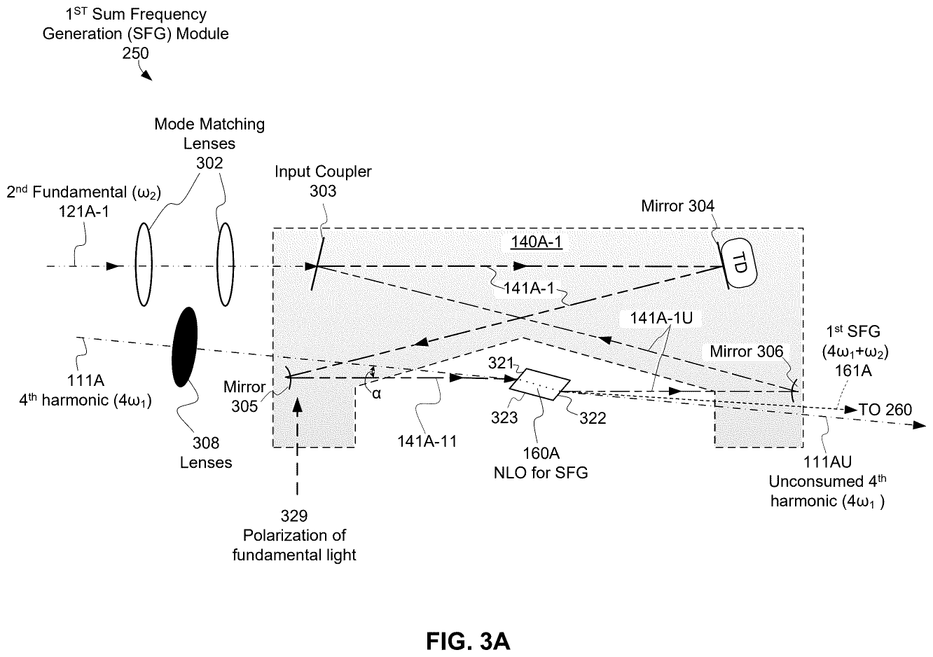

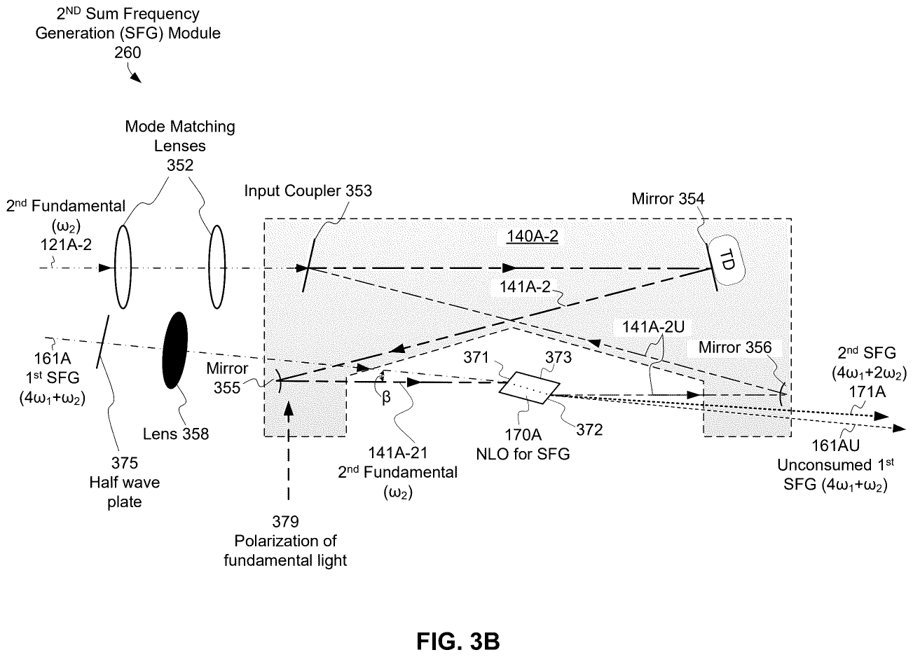

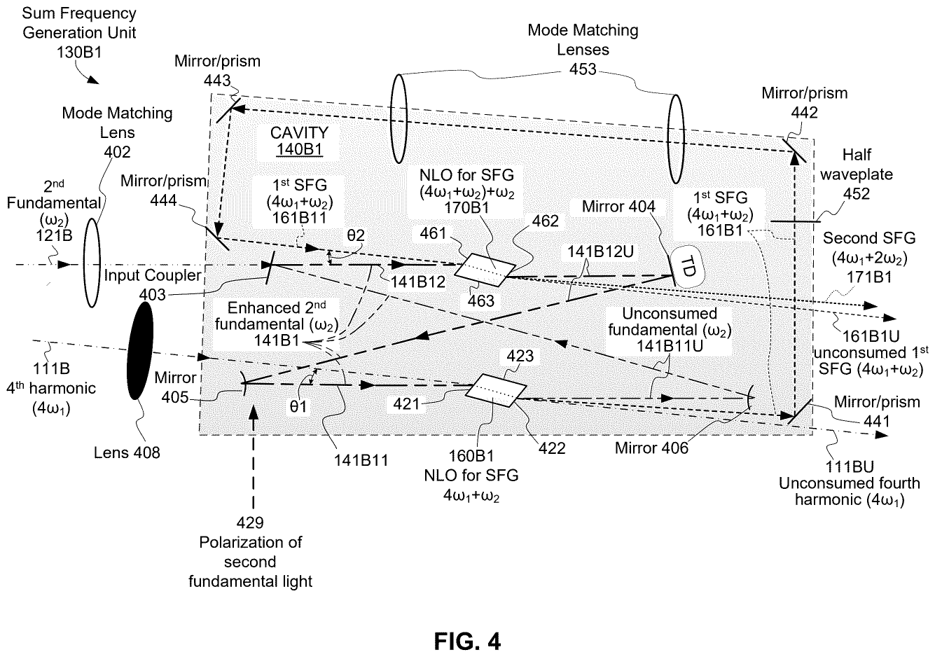

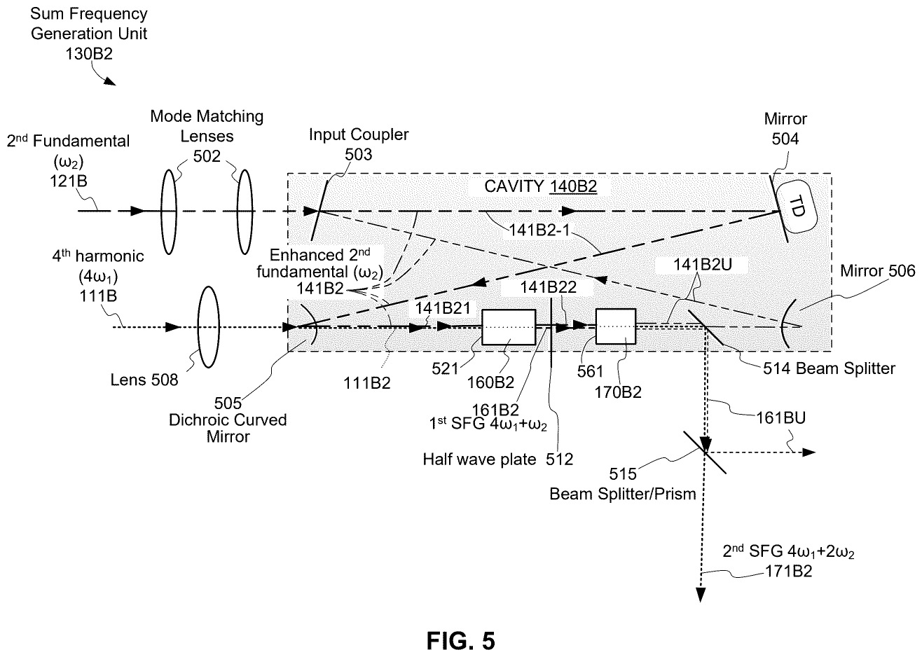

Laser assemblies 100A (FIG. 2A) and 100B (FIG. 2B) differ in the details of their respective SFG (frequency mixing) units 130A and 130B. That is, both SFG units 130A (FIG. 2A) and 130B (FIG. 2B) utilize at least one external resonant cavity configured to resonate at second fundamental frequency @s to generate the enhanced second fundamental light required to facilitate the sum-frequency generation of laser output light at a wavelength of approximately 193 nm with a power of 1 W or more. However, SFG unit 130A (FIG. 2A) is distinguished in that second fundamental light 121A is split by a beam splitter 210 into two CW portions 121A-1 and 121A-2 that are respectively optically coupled to two separate external resonant cavities 140A-1 and 140A-2, which are respectively included in a first SFG module 250 and a second SFG module 260. That is, first SFG module 250 includes (first) resonant cavity 140A-1 and first NLO crystal 160A, where resonant cavity 140A-1 is configured to enhance first CW portion 121A-1 of second fundamental (second CW) light 121A, and first NLO crystal 160A is utilized to mix the enhanced fundamental light with fourth harmonic (first CW) light 111A to generate first SFG light 161A at a (second DUV) frequency 4ω₁+ω₃. Similarly, second SFG module 260 includes (second) resonant cavity 140A-2 and second NLO crystal 170A, where resonant cavity 140A-2 is configured to enhance second CW portion 121A-2 of second fundamental light 121A, and second NLO crystal 160A is utilized to mix (i.e., by way of sum-frequency generation) the enhanced fundamental light generated by resonant cavity 140A-2 with SFG light 161A to generate output (second SFG) light 171A at output (third DUV) frequency 4ω₁+2ω₂. In contrast, SFG unit 130B (FIG. 2B) includes a single resonant cavity 140B that is positioned to receive all of second CW light 121B generated by second laser source 102 (FIG. 1) and is configured to generate enhanced fundamental light 141B that is circulated along a single closed optical path COP, both first NLO crystal 160B and second NLO crystal 170B are positioned in closed optical path COP such that first NLO crystal 160B receives a first enhanced CW light portion 141B-1 and second NLO crystal 170B receives a second enhanced CW light portion 141B-2, and resonant cavity 140B is further configured such that first SFG light 161B is directed to second NLO crystal 170B. Similar to SFG unit 130A (FIG. 2A) first NLO crystal 160B is utilized to mix a first portion of enhanced fundamental light 141B with fourth harmonic (first CW) light 111B to generate SFG light 161B at frequency 4ω₁+ω₂, and second NLO crystal 170B is utilized to mix a second portion of enhanced fundamental light 141B with SFG light 161B to generate output (second SFG) light 171B at frequency 4ω₁+2ω₂. SFG modules 250 and 260 (FIG. 2A) are described in additional detail below with reference to FIGS. 3A and 3B, respectively, and SFG unit 130B (FIG. 2B) is described in additional detail below with reference to the two alternative exemplary embodiments depicted in FIGS. 4 and 5.

Note that, although FIGS. 2A and 2B respectively depict laser assemblies 100A and 100B as being divided into distinct units/modules such as first and second fundamental lasers 201 and 202, fourth harmonic generation module 240 and SFG units 130A and 130B, the depicted division is provided merely for convenience of explaining the operation of the laser and the functions of its components. An actual implementation of laser assemblies 100A and/or 100B may group the various functions and modules differently than depicted than in FIGS. 2A and 2B. For example, first fundamental laser 201 and first frequency doubling cavity 220 may be combined into a laser apparatus that generates a visible wavelength, such as a wavelength in a range between about 505 nm and 545 nm, corresponding to second harmonic frequency 2ω₁. Such laser apparatus may be available from the same suppliers mentioned above with reference to the two fundamental lasers. The output of this laser apparatus would be supplied to second frequency doubling cavity 230.

FIG. 2C shows a table of exemplary wavelengths generated by and mixed within the laser assemblies of FIGS. 2A and 2B to generate CW output light 171A and 171B with a wavelength of approximately 193 nm in accordance with alternative embodiments of the present invention. For each first fundamental laser type, an exemplary first fundamental wavelength is shown, along with the wavelengths corresponding to the harmonics and an exemplary second fundamental laser type (lasing medium) along with the generated second wavelength required for the desired output wavelength. The exact wavelength of a fundamental laser depends on many factors including the exact composition of the lasing medium, the operating temperature of the lasing medium, and the design of the optical cavity. Two lasers using the same laser line of a given lasing medium may operate at wavelengths that differ by a few tenths of 1 nm or a few nm. One skilled in the appropriate arts would understand how to choose the appropriate second fundamental wavelength in order to generate the desired output wavelength from any first fundamental wavelength similar to those listed in the table. Similarly, if the desired output wavelength differs from 193 nm by a few nm, the desired output wavelength can also be achieved by an appropriate adjustment of the wavelengths of one, or both, of the first and the second fundamental lasers.

In alternative embodiments, first fundamental laser 201 is configured to generate fundamental light 211 at first fundamental frequency ω₁ having a corresponding wavelength equal to one of approximately 1029 nm, approximately 1087 nm, approximately 1047 nm, and approximately 1011 nm, and second fundamental laser 202 is configured to generate the second fundamental light at a second fundamental frequency ω₂ that, when mixed with the fourth harmonic (first CW) light 111 (4ω₁) to generate first SFG light 161, and then mixed a second time with first SFG light 161, produces CW output light 171 at approximately 193 nm. By way of example, when a given laser assembly includes a first fundamental laser 201 that generates first fundamental light 211 with a first fundamental wavelength of approximately 1029 nm, the laser assembly is configured to include a second fundamental laser 202 that is capable of generating second fundamental light at a second fundamental frequency with a corresponding wavelength of approximately 1557 nm, whereby the laser assembly's CW output light is generated with a wavelength of approximately 193 nm. Alternatively, when a given laser assembly includes a first fundamental laser 201 that generates first fundamental light 211 with a first fundamental wavelength of approximately 1087 nm, the laser assembly is configured to include a second fundamental laser 202 that is capable of generating second fundamental light at a second fundamental frequency with a wavelength of approximately 1342 nm, whereby the laser assembly's CW output light is generated with a wavelength of approximately 193 nm. Fundamental lasers capable of generating at least one of these second fundamental frequencies are typically readily available at reasonable prices in various power levels. For example, Yb-doped fiber lasers generating a wavelength of approximately 1029 nm and erbium (Er)-doped fiber lasers generating a wavelength of approximately 1557 nm are available at power levels up to tens of W. If 1029 nm is used as the first fundamental wavelength and 1557 nm is used as the second fundamental wavelength, then the generated fourth harmonic wavelength is approximately 257.3 nm, while the first SFG wavelength by mixing the fourth harmonic with the second harmonic is at approximately 220.8 nm and the desired laser output at a wavelength of approximately 193.4 nm from the second SFG is generated by mixing the first SFG at 220.8 nm with the second fundamental light at 1557 nm. Similarly, Nd:YVO₄ lasers generating laser light with a wavelength of 1342 nm are available at power levels up to tens of W, and when mixed with the fourth harmonic of the first fundamental laser having wavelength at 1087 nm, will produce a first SFG output at 226.0 nm, then a portion of the second fundamental light at a wavelength at 1087 nm is mixed with the first SFG light with wavelength at 226.0 nm to generate the desired wavelength at 193.4 nm. If an Er:YAG (erbium-doped yttrium aluminum garnet) laser generating a wavelength of approximately 1645 nm is mixed with the fourth harmonic of the first fundamental laser having a wavelength at 1011 nm to generate first SFG light with a wavelength of 219.2 nm, then mixing the first SFG light with the second fundamental laser at 1011 nm, a laser output at 193.4 nm will be produced. If a Raman fiber laser is used to generate a second fundamental wavelength of approximately 1481 nm, which is mixed with the fourth harmonic of a first fundamental laser with having wavelength at 1047 nm to generate first SFG light with wavelength at 222.4 nm, then that first SFG light is mixed with the second fundamental laser at 1481.3 nm, a laser output at a wavelength of approximately 193.4 nm is produced. With the second fundamental light circulating in an external resonant cavity (or inside a solid-state laser cavity), the intra-cavity power level of the second fundamental light may be boosted to a few kW or even higher, so the two SFG conversion stages can be efficient allowing stable output at power levels in a range from hundreds of mW to a few W or more.

The wavelength combinations mentioned above are merely examples and are not meant to limit the scope of the invention. One skilled in the appropriate arts understands how to choose different combinations of wavelengths, NLO crystal temperatures and angles in the various frequency conversion modules to achieve phase matching and a desired output wavelength.

FIG. 3A is a simplified diagram showing a SFG module 250 utilized in CW laser assembly 100A of FIG. 2A according to an exemplary embodiment of the present invention. SFG module 250 includes first resonant cavity 140A-1 and first NLO crystal 160A. Resonant cavity 140A-1 includes an input coupler 303 that serves to admit first CW portion 121A-1 and also serves as one of four reflective surfaces including cavity mirrors 304, 305 and 306 that are operably arranged to form a bowtie ring cavity (first optical path). First CW portion 121A-1 of second fundamental (second CW) light enters resonant cavity 140A-1 by way of input coupler 303 and combines with recirculated (unconsumed) enhanced CW light portion 141A-1U to generate enhanced CW light portion 141A-1 that is directed along the bowtie-shaped (first) optical path by mirrors 304 and 305 to NLO crystal 160A. First NLO crystal 160A includes an input surface 321, an output surface 322 and parallel side surfaces 323, and is positioned along a portion of the first optical path between curved mirrors 305 and 306 such that a first beam segment 141A-11 of enhanced CW light portion 141A-1 is directed at a predetermined angle from mirror 305 onto input surface 321 and unconsumed enhanced CW light 141A-1U passes from output surface 322 to mirror 306. First NLO crystal 160A is also positioned such that fourth harmonic (first CW) light 111A is directed onto input surface 321 and unconsumed fourth harmonic light 111AU exits NLO crystal 160A through output surface 322. First NLO crystal 160A functions to mix enhanced CW light portion 141A-1 (i.e., received by way of first beam segment 141A-11) and fourth harmonic light 111A to generate first SFG light 161A, which also exits NLO crystal 160A through output surface 322. In the embodiment illustrated in FIG. 3A, both input surface 321 and output surface 322 of crystal 309 are configured (cut and positioned) so as to be approximately at Brewster's angle relative to polarization of first beam segment 141A-11 (i.e., relative to the direction indicated by arrow 329 in the cavity plane of FIG. 3A, which is typically also close to the Brewster's angle of incoming fourth harmonic light 111A or outgoing first SFG light 161A). This angle minimizes reflection of both the second fundamental light and the fourth harmonic light by input surface 321 for type-I phase matching or second fundamental and the first SFG light for type-II phase matching and thus avoids the need for an antireflection coating on both input surface 321 and output surface 322 of NLO crystal 160A. An advantage of not coating crystal surfaces 321 and 322 is that antireflection coatings can have a short lifetime when exposed to intense UV radiation, thereby increasing operating and maintenance costs. SFG module 250 is configured such that both fourth harmonic light 111A and first beam segment 141A-11 enter NLO crystal 160A in a direction approximately at Brewster's angle relative to input surface 321 and then propagate approximately collinearly inside the NLO crystal 160A (e.g., in direction parallel to side surface 323). To achieve this, fourth harmonic light 111A needs to be directed at slightly deviated angle α (e.g., an angle between about 2° and 10°, or an angle between about 5° and 7°) from first beam segment 141A-11 due to the chromatic dispersion of NLO crystal 160A. The generated sum-frequency light 161A, having second DUV frequency equal to 4ω₁+ω₂ and the unconsumed fourth harmonic light 111AU (4ω₁) also exits through the Brewster-cut crystal surface 322 at slightly deviated angles from unconsumed second fundamental light 141A-1U. In some embodiments (as illustrated in FIG. 3A), deviated angle α is large enough to prevent interference of fourth harmonic light 111A by mirror 305 (i.e., incoming fourth harmonic light 111A is separated from enhanced CW light beam segment 141A-11 far enough so that mirror 305 is not the in the beam path of fourth harmonic light 111A), and prevent interference of unconsumed fourth harmonic light 111AU and SFG light 161A by mirror 306 (i.e., so that both unconsumed fourth harmonic light 111AU and generated SFG light 161A are sufficiently separated from unconsumed second fundamental 141A-1U such that mirror 306 is not in the beam path of outgoing unconsumed fourth harmonic light 111AU and SFG light 161A). This arrangement facilitates coating mirrors 305 and 306 only for high reflection at second fundamental (IR) wavelength of enhanced CW light portion 141A-1. That is, no DUV light circulates in resonant cavity 140A-1, so coating damage due to exposure to DUV radiation is not an issue.

FIG. 3B is a simplified diagram showing an SFG module 260 utilized in CW laser assembly 100A of FIG. 2A according to an exemplary embodiment. SFG module 260 includes second resonant cavity 140A-2 and second NLO crystal 170A. Resonant cavity 140A-2 includes four reflective surfaces including an input coupler 353 and cavity mirrors 354, 355 and 356 that are arranged to form a bowtie ring (second optical path). SFG module 260 operates in a similar way to SFG module 250 (FIG. 3A), wherein second CW portion 121A-2 of second fundamental (second CW) light enters resonant cavity 140A-2 by way of input coupler 353 and is combined with recirculated (unconsumed) second CW light 141A-2U to generate (second) enhanced CW light portion 141A-2 that is directed by the bowtie ring to NLO crystal 170A. NLO crystal 170A includes an input surface 371, an output surface 372 and parallel side surfaces 373, and is positioned in the optical path between mirrors 355 and 356 such that a (second) beam segment 141A-21 of enhanced CW light portion 141A-2 is directed from mirror 355 onto input surface 371 and unconsumed enhanced CW light 141A-2U passes from output surface 352 such that it is reflected (recirculated) by mirrors 356 and 353 and combines with second CW portion 121A-2 to form enhanced CW light 141A-2. NLO crystal 170A is also positioned such that first SFG light 161A is directed onto input surface 371 and unconsumed first SFG light 161AU exits NLO crystal 170A through output surface 372. Similar to NLO crystal 160A, NLO crystal 170A functions to mix enhanced CW light portion 141A-2 (ω₂) and first SFG light 161A (4ω₁+ω₂) to generate CW output (second SFG) light 171A, which also exits NLO crystal 170A through output surface 372. As illustrated in FIG. 3B, in some embodiments both input surface 371 and output surface 372 of crystal 170A are cut and positioned so as to be approximately at Brewster's angle relative to polarization of the enhanced CW light beam segment 141A-21 (i.e., relative to the direction indicated by arrow 379 in the cavity plane of FIG. 3B, which is typically also close to the Brewster's angle of first SFG light 161A entering NLO crystal 170A (if type-I phase matching of the sum-frequency generation is used) or close to the Brewster's angle of outgoing second SFG light 171A (if type-II phase matching configuration is used), wherein a half waveplate 375 can be used the rotate the polarization of incoming first SFG light 161A if desired. This angle minimizes reflection of both the second fundamental (ω₂) and the first SFG light (4ω₁+ω₂) for type-I phase matching or both second fundamental (ω₂) and the second SFG light (4ω₁+2ω₂) for type-II phase matching, thus avoiding the need for anti-reflection coatings on both input surface 371 and output surface 372 of NLO crystal 170A. NLO crystal 170A is positioned to receive both first SFG light 161A and enhanced fundamental light beam segment 141A-21 such that both first SFG light 161A and the second fundamental light beam segment 141A-21 enter input surface 371 in direction approximately at Brewster's angle relative to the crystal surface 371 and propagate inside NLO crystal 170A approximately collinearly (e.g., in a direction parallel to the crystal surface 373). To achieve this, incoming SFG light 161A must be directed at a slightly deviated angle β (such as an angle between about 2° and 10°, or an angle between about 5° and 7°) relative to second fundamental light beam segment 141A-21 due to the chromatic dispersion of NLO crystal 170A. In the meantime, the newly generated second SFG (output) light 171A (4ω₁+2ω₂) and unconsumed first SFG light 161AU (4ω₁+ω₂) also exit through the Brewster-cut crystal at slightly deviated angles from unconsumed enhanced fundamental 141A-2U. In some embodiments (as illustrated in FIG. 3B), incoming first SFG light 161A is separated from enhanced CW light beam segment 141A-21 far enough so that mirror 355 is not the in the beam path of first SFG light 161A, and unconsumed first SFG light 161A and outgoing second SFG (CW output) light 171A are separated from unconsumed second fundamental 141A-2U far enough so that mirror 356 is not in the beam path of unconsumed first SFG light 161A and outgoing second SFG light 171A. This arrangement facilitates coating mirrors 355 and 356 only for high reflection at second fundamental (IR) wavelength of enhanced CW light portion 141A-2. That is, no DUV light circulates in resonant cavity 140A-2, so coating damage due to exposure to DUV radiation is not an issue. As is known in the art, different wavelengths have different refractive indexes, so angle α is chosen carefully and needs to be well aligned so that incoming fourth harmonic light 111A and enhanced fundamental light beam portion 141A-11 substantially overlap inside NLO crystal 160A. In a practical example, when CLBO crystals are utilized and the fourth harmonic and second fundamental wavelengths are about 257 nm and 1557 nm, respectively, angle α should be approximately 5.5°, and angle β should be approximately 6.5°. Other wavelength combinations will change these optimal numbers by about one degree or less for CLBO, and the use of BBO or LBO crystals will likely change these angles by a few degrees. Since the NLO crystals have a finite length (for example, a typical length may be between about 5 mm and 20 mm), small deviations (such as a deviation of about a degree or less) from the optimal angle may still allow substantial overlap of the light beams within the crystal while giving flexibility to avoid the mirrors interfering with light beams and/or to separate the beams leaving the NLO crystal.

In some embodiments SFG module 250 (FIG. 3A) and/or SFG module 260 (FIG. 3B) utilize additional optical elements to maximize conversion efficiency. Referring to FIG. 3A, incoming first CW portion 121A-1 is focused by one or more optical elements (lens/lenses and/or curved mirror/mirrors) 302 before entering resonant cavity 140A-1 to match the intrinsic mode of the resonant cavity, which has a beam waist inside or proximate to first NLO crystal 160A, while incoming fourth harmonic light 111A is directed by mirrors or prisms (not shown) at a slightly deviated angle from enhanced CW light beam segment 141A-11 and focused by one or more optical elements (lens/lenses and/or curved mirror/mirrors) 308 to a corresponding beam waist (not shown) disposed inside or proximate to first NLO crystal 160A. Similarly, as shown in FIG. 3B, incoming second fundamental light (second CW) portion 121A-2 is focused by one or more optical elements (lens/lenses and/or curved mirror/mirrors) 352 before entering resonant cavity 140A-2 to match the intrinsic mode of the resonant cavity, which has a beam waist inside or proximate to NLO crystal 170A, while incoming first SFG light 161A is directed by mirrors or prisms (not shown) at a slightly deviated angle from enhanced CW light beam segment 141A-21 and focused by a lens or lens set 358 to a corresponding beam waist (not shown) disposed inside or proximate to NLO crystal 170A. In each case, if the power of enhanced fundamental light portions 141A-1 and 141A-2 respectively circulating in resonant cavities 140A-1 and 140A-2 is intense enough, the conversion efficiency from the fourth harmonic light (4ω₁) to the first SFG light (4ω₁+ω₂) in first NLO crystal 160A (FIG. 3A) and the conversion from the first SFG light (4ω₁+ω₂) to the second SFG light (4ω₁+2ω₂) in NLO crystal 170A (FIG. 3B) is very high, up to or even higher than 50%. In this embodiment, the sum-frequency light is generated using only cavities resonating at the second fundamental frequency ω₂.

In some embodiments one or both of SFG module 250 (FIG. 3A) and/or SFG module 260 (FIG. 3B) may be modified from the depicted arrangements to facilitate operation. For example, in some embodiments the separation required for incoming fourth harmonic light 111A and second fundamental light beam segment 141A-11 to enter first NLO crystal 160A collinearly (FIG. 3A) may not be large enough to avoid mirror 305 being in the beam path of incoming fourth harmonic light 111A, and/or the separation required for incoming first SFG light 161A and second fundamental light beam segment 141A-21 to enter NLO crystal 170A collinearly (FIG. 3B) may not be large enough to avoid mirror 355 being in the beam path of incoming first SFG light 161A. Similarly mirror 306 may be in the beam path of unconsumed/outgoing fourth harmonic light 111AU and outgoing first SFG light 161A (FIG. 3A), and/or mirror 356 may be in the beam path of unconsumed first SFG light 161AU and outgoing second SFG (CW output) light 171A (FIG. 3B). In some other embodiments, an NLO crystal with normal incidence with appropriate coating may be implemented and fourth harmonic light 111A (FIG. 3A) or first SFG light 161A (FIG. 3B) travels collinearly and the sum-frequency light travels almost collinearly (only at a very small walk-off angle) with the second fundamental light outside the crystal in the cavity. In those cases, mirrors 305/306 or 355/356 may be dichroic coated appropriately to allow the fourth harmonic and/or the first sum-frequency light and/or the second sum-frequency light to pass through efficiently while reflecting the second fundamental light with high efficiency, or beam splitters or dichroic mirrors (not shown) may be inserted on the left and/or right side of the NLO crystals to separate and direct the unconsumed fourth harmonic and first SFG from the second fundamental light in module 250 or first SFG light and second SFG light from the second fundamental light in module 260.

In some embodiments one or both of SFG module 250 (FIG. 3A) and/or SFG module 260 (FIG. 3B) may utilize an optional beam splitter or wavelength separator outside of resonant cavities 140A-1 and/or 140A-2 to further separate out any unconsumed fourth harmonic light 111AU (and perhaps also leakage of the unconsumed enhanced CW light beam segment 141A-12) from first SFG light 161A and/or unconsumed first SFG light 361 (and perhaps also leakage of unconsumed enhanced CW beam light segment 141A-22) from the second SFG (CW output) light 171A. The beam splitter or wavelength separator may comprise a prism, a polarizing beam splitter, a dichroic beam splitter or a combination of optical elements.

In a preferred embodiment, NLO crystals 160A and/or 170A comprise an annealed (deuterium-treated or hydrogen-treated) cesium lithium borate (CLBO) crystal and the annealed CLBO crystal is held at a constant temperature of approximately 80° C. or lower during operation. In other embodiments, SFG modules 250 and/or 260 may comprise a BBO, an LBO or other NLO crystal for frequency mixing. LBO and CLBO have smaller walk-off angles for these combinations of wavelengths and hence may enable more efficient conversion through using longer crystals than is possible with BBO. CLBO is particularly attractive because of its low absorption and high damage threshold for wavelengths shorter than about 300 nm.

Although first resonant cavity 140A-1 (FIG. 3A) second resonant cavity 140A-2 (FIG. 3B) are implemented using bowtie cavity arrangements in the depicted examples, one or both cavities 140A-1 and 140A-2 may be implemented using another cavity type. For example, instead of having a bowtie cavity, other shapes of cavity such as a delta shape or a standing-wave cavity may be used. If a standing-wave cavity is used, the sum-frequency light is generated in the same direction as the injected fourth harmonic light or first SFG light. The cavities can be stabilized with standard PDH or HC locking techniques. The cavity length is adjusted to maintain resonance by adjusting the position of a mirror (such as the mirror 304 in FIG. 3A and mirror 354 in FIG. 3B) or a prism by way of a control signal (not shown). For example, mirror 304 is mounted on a transducer TD (such as a piezo-electric transducer or a voice-coil transducer) that actively responds to the control signal to facilitate controlling the cavity length (resonance condition) of resonant cavity 140A-1.

FIGS. 4 and 5 are simplified diagrams showing SFG units 130B1 and 130B2, either of which may be used to implement SFG unit 130B of CW laser assembly 100B (FIG. 2B) according to alternative exemplary embodiments of the present invention. As described above with reference to FIG. 2B, SFG unit 130B performs the two frequency mixing steps using a single external resonant cavity 140B that receives and circulates all of second fundamental light 121B generated by second laser light source 120B to generate enhanced fundamental light 141B, and SFG unit 130B is configured to direct a first portion 141B-1 of enhanced fundamental light 141B at second fundamental frequency ω₂ and fourth harmonic (first CW) light 111B at fourth harmonic (first DUV) frequency 4ω₁ through NLO crystal 160B to generate first SFG light 161B at (second DUV) frequency 4ω₁+ω₂, and to direct a second portion 141B-2 of enhanced fundamental light 141B at second fundamental frequency ω₂ and first SFG light 161B at (second DUV) frequency 4ω₁+ω₂ through NLO crystal 170B to generate second SFG (CW output) light 171B at (third DUV) frequency 4ω₁+2ω₂. As set forth below, both SFG unit 130B1 (FIG. 4) and SFG unit 130B2 (FIG. 5) combine the two sum-frequency generation (mixing) operations with two NLO crystals in a single resonant cavity. Note that, because both first enhanced fundamental light portion 141B1 and second enhanced fundamental light portion 141B-2 are generated by a single cavity, these portions may be considered as beam segments of enhanced fundamental light 141B1, for example, when entering NLO crystals 160B1 and 170B1, respectively.

Referring to SFG unit 130B1 (FIG. 4), resonant cavity 140B1 utilizes four reflective optical elements (e.g., mirrors) to generate enhanced CW light 141B in a manner similar to that utilized by SFG modules 250 and 260 (described above with reference to FIGS. 3A and 3B). That is, resonant cavity 140B includes an input coupler 403 and mirrors 404, 405 and 406 that are arranged (i.e., in combination with NLO crystals 160B and 170B, as discussed below) to form a bowtie shaped (closed) optical path OP that is resonant at second fundamental frequency ω₂. Second fundamental (second CW) light 121B enters resonant cavity 140B through input coupler (third mirror) 403 and joins with recirculated unconsumed fundamental light 141B11U to generate enhanced CW light portion 141B12 that is directed along a corresponding segment of the closed optical path extending from input coupler 403 to input surface 461 of NLO crystal 170B1. Input coupler 403 is partially reflective in a way that both serves to admit second fundamental light 121B and to reflect circulated unconsumed enhanced CW light 141B11U received from mirror 406. In some embodiments, one or more optical elements (e.g., a mode matching lens/lenses or mirror/mirrors) 402 are utilized to direct second fundamental light 121B into resonant cavity 140B. Unconsumed enhanced CW light 141B12U is directed from output surface 462 of second NLO crystal 170B1 to mirror 404, which reflects enhanced CW light 141B12U to mirror 405. Mirror 404 is mounted on a transducer TD (such as a piezo-electric transducer or a voice-coil transducer) to actively control the cavity length of the main the resonance condition of resonant cavity 140B. Enhanced light reflected by mirror 405 forms enhanced CW light portion (beam segment) 141B11 that is directed along a corresponding segment of the closed optical path extending from mirror 405 to input surface 421 of first NLO crystal 160B1. Unconsumed enhanced CW light 141B11U is directed from output surface 422 of NLO crystal 160B1 to curved mirror 406, which reflects enhanced CW light 141B11U to input coupler 403. Note that, unlike SFG unit 130A (FIG. 2A) in which the second fundamental light is split into two portions, all of second fundamental (second CW) light 121B is directed into resonant cavity 140B, whereby the enhanced power of enhanced CW light 141B may be substantially higher than that achieved in SFG module 250 and SFG module 260. Resonant cavity 140B is also configured such that enhanced CW light 141B1 forms two beam waists at corresponding positions along the closed optical path, one being located between input coupler 403 and mirror 404 (preferably inside or close to NLO crystal 170B1), the other being located between curved mirrors 405 and 405 (preferably inside or close to NLO crystal 160B1). One or more optical elements (e.g., a mode matching lens/lenses or mirror/mirrors) 408 focuses fourth harmonic light 111B near the center of NLO crystal 160B1 with a beam size close to or smaller than the second fundamental beam size.

Similar to the embodiments described above, input surface 421 and output surface 422 of NLO crystal 160B1 as well as input surface 461 and the output surface 462 of NLO crystal 170B are cut and positioned so as to be approximately at Brewster's angle relative to a polarization of the second fundamental light 141B1 (e.g., as indicated by arrow 429 in the cavity plane of FIG. 4). Typically, orientating the input/output surfaces in this manner will also be close to the Brewster's angle of fourth harmonic light 111B1 entering NLO crystal 160B1 (for type-I phase matching) or the Brewster's angle of outgoing first SFG light 161B1 exiting NLO crystal 160B1 (for type-II phase matching) and the first SFG light section 161B11 entering NLO crystal 170B1 (for type-I phase matching) or the second SFG (output CW) light 171B1 exiting NLO crystal 170B1 (for type-II phase matching). This angle minimizes reflection of the second fundamental light (ω₂), the fourth harmonic light (4ω₁), and the first SFG light (4ω₁+ω₂) or the second SFG light (4ω₁+2ω₂) and thus facilitates avoiding the need for an anti-reflection coating on both input surfaces 421/461 and output surfaces 422/462 of the NLO crystals in some embodiments. The advantage of not coating crystal surfaces is that coatings can have a short lifetime when exposed to intense UV radiation.

NLO crystal 160B1 is positioned to receive at input surface 421 both fourth harmonic (first CW) light 111B and enhanced CW light portion (beam segment) 141B11 such that both the fourth harmonic light (4ω₁) and the enhanced second fundamental light (ω₂) enter NLO crystal 160B1 approximately in a direction close to Brewster angle and then propagate almost collinearly inside NLO crystal 160B1 (e.g., in direction parallel to crystal side surface 423). To achieve this, fourth harmonic light 111B1 is directed at a slightly deviated angle θ1 relative to the direction of enhanced CW light portion 141B11 due to the chromatic dispersion of the NLO crystal. In the meantime, generated first SFG light 161B1 (4ω₁+ω₂) and unconsumed fourth harmonic light 111B1U (4ω₁) exits through the Brewster-cut output surface 422 of NLO crystal 160B1 at slightly deviated angles from unconsumed enhanced CW light 141B11U. In some embodiments first SFG light 161B1 and unconsumed fourth harmonic light 111B1U exit the Brewster-cut output surface 422 of NLO crystal 160B1 at slightly deviated angles from enhanced CW light 141B11U. In a presently preferred embodiment (as illustrated in FIG. 4), unconsumed first SFG light 161B1U and second SFG light 171B1 are separated from unconsumed enhanced CW light 141B12U far enough so that mirror 403 is not the in the beam path of incoming first SFG light portion 161B11 and mirror 404 is not in the beam path of second SFG light 171B1 or unconsumed first SFG light 161B1U, therefore mirrors 403 and 404 are coated only for high reflection at the second fundamental wavelength (ω₂). In this embodiment, there are no DUV coatings in resonant cavity 140B1, so coating damage when exposed to DUV radiation is not an issue.

After exiting through output surface 422 of first NLO crystal 160B1, first SFG light 161B1 is reflected and directed by multiple optical elements (e.g., mirrors/prisms 441, 442, 443 and 444, shown in FIG. 4 only for illustration purposes; the actual quantity could be more or fewer) to second NLO crystal 170B1 such that a final beam segment 161B11 of first SFG light 161B1 is directed at a slightly deviated angle θ2 relative to enhanced CW light portion (beam segment) 141B12 onto input surface 461 due to the chromatic dispersion of the NLO crystal so that SFG light beam segment 161B11 and enhanced CW light portion 141B12 propagate inside NLO crystal 170B1 almost collinearly along the same direction (e.g. in a direction parallel to side surface 463). One or more optical elements (e.g., a mode matching lens/lenses or mirror/mirrors) 453 may be used to shape first SFG light 161B1 to the desired beam waist size and position which preferably is near or inside NLO crystal 170B1. An optional half waveplate 452 can be used to rotate the polarization of first SFG light 161B1 if desired so that the polarization of SFG light 161B1 before entering NLO crystal 170B1 is aligned with the phase matching condition of NLO crystal 170B1. CW output (second SFG) light 171B1 and unconsumed first SFG light 161B1U also exit through the Brewster-cut NLO crystal 170B1 at slightly deviated angles from unconsumed second fundamental light 141B12U. In a presently preferred embodiment (as illustrated in FIG. 4), unconsumed first SFG light 161B1U and second SFG light 171B1 are separated from unconsumed enhanced CW light 141B12U far enough so that mirror 403 is not the in the beam path of incoming first SFG light portion 161B11 and mirror 404 is not in the beam path of second SFG light 171B1 or unconsumed first SFG light 161B1U, therefore mirrors 403 and 404 are coated only for high reflection at the second fundamental wavelength (ω₂). In this embodiment, there are no DUV coatings in resonant cavity 140B1, so coating damage when exposed to DUV radiation is not an issue.

In some of the alternative embodiments, the position of NLO crystals 160B1 and 170B1 within cavity 140B1 could be swapped along with the corresponding incoming light or the generated SFG light, or the position of the curved mirrors and flat mirrors could be changed or flipped while satisfying the cavity stability condition. Also, although the bowtie cavities of the various embodiments described herein are depicted as including two flat mirrors and two curved mirrors, in some embodiments all four mirrors directing the circulating light at the second fundamental frequency are curved mirrors, for example, to achieve reasonable beam sizes at the crystal location(s).

SFG unit 130B2 (FIG. 5) depicts an alternative embodiment in which two NLO crystals 160B2 and 170B2 and a single resonant cavity 140B2 are utilized to generate 193 nm CW output light 171B2. Resonant cavity 140B2 is configured to receive all of the second CW light 121B produced by a second CW laser light source 102 (shown in FIG. 2B) and utilizes an input coupler 503 and cavity mirrors 504, 505 and 506 to generate and circulate enhanced CW light 141B2 around a bowtie-shaped (closed) optical path in a manner similar to that described above with reference to resonant cavity 140B1. Also similar to previous embodiments, NLO crystals 160B2 and 170B2 are positioned in the closed optical path formed by resonant cavity 140B2 and are configured such that NLO crystal 160B2 receives and mixes a first enhanced CW light portion (beam segment) 141B21 with first CW (fourth harmonic) light 111B produced by first CW laser light source 101 (shown in FIG. 2B) to generate first SFG light 161B2, and NLO crystal 170B2 receives and mixes a second enhanced CW light portion (beam segment) 141B22 with first SFG light 161B2 to generate CW output light 171B2. Also similar to previous embodiments, one or more optical elements (e.g., a mode matching lens or lens pair or curved mirror(s)) 502 directs second CW light 121B into cavity 140B2 by way of input coupler 503, and a lens 508 focuses fourth harmonic light 111B (4ω₁) near the center of NLO crystal 160B2 with a beam size close to or smaller than that of enhanced CW light portion 141B2 inside NLO crystal 160B2.

SFG unit 130B2 differs from SFG 130B1 (FIG. 4) in several respects. For example, both NLO crystals 160B2 and 170B2 have normalized input/output surfaces (i.e., both input surfaces 521 and 561 of NLO crystals 160B2 and 170B2 and their opposing output surfaces are maintained substantially perpendicular to the incoming and outgoing light beams). In addition, both NLO crystals 160B2 and 170B2 are arranged in series (i.e., such that first SFG light 161B2 exiting NLO crystal 160B2 is directly received at input surface 561 of the second NLO crystal 170B2), and the various light beams are directed collinearly through the two NLO crystals. That is, first CW (fourth harmonic) light 111B (4ω₁) and enhanced CW light portion 141B21 (ω₂) are directed collinearly onto input surface 521 and into NLO crystal 160B2. NLO crystal 160B2 sums enhanced CW light portion 142B21 and first CW light 111B2 to create first SFG light 161B2 having a DUV frequency equal to 4ω₁+ω₂. Outgoing first SFG light 161B2 travels almost collinearly with unconsumed enhanced CW light portion 141B22 over a small offset distance in the walk-off direction from the output surface of first NLO crystal 160B2 to input surface 561 of second NLO crystal 170B2. Then unconsumed enhanced CW light portion (second beam segment) 141B22 and first SFG light 161B2 are mixed again in NLO crystal 170B2 to generate CW output (second SFG) light 171B2. A half waveplate 512 can be used to rotate the polarization of first SFG light 161B2 (4ω₁+ω₂) if desired so that the polarization of the first SFG light before entering the crystal 170B2 is aligned with the phase matching condition of the nonlinear crystal 170B2. In some embodiments, NLO crystals 160B2 and 170B2 are placed very close to each other and near the cavity intrinsic waist position so that beam sizes of the second fundamental beam and the fourth harmonic beam inside NLO crystal 160B2 are small enough while the second harmonic beam and the first generated SFG beam size are also small enough for good conversion efficiency. In one embodiment, the two NLO crystals are oriented so the walk-off direction of the corresponding SFG are rotated 180° with respect to one another, so that the second SFG conversion efficiency could be optimized. Since the light is incident at normal incidence on the NLO crystal surfaces, one or more of the surfaces of the two crystals may be coated to reduce reflection losses.

In some embodiments cavity mirror 505 has an appropriate dichroic coating to allow first CW light 111B having fourth harmonic frequency 4ω₁ to pass through efficiently while reflecting enhanced CW light 141B2 having the second fundamental frequency ω₂ with high efficiency. A beam splitter 514 is placed to the right of NLO crystal 170B2 to transmit unconsumed second CW light 141B22 to mirror 506 and to direct CW output (second SFG) light 171B2 and unconsumed first SFG light 161B2U toward an additional beam splitter/prism 515. An additional beam splitter or prism 515 can be implemented further to separate CW output light 171B2 from unconsumed first SFG light 161B2U. In some embodiments, the enhanced CW light, the first SFG light and the CW output light may be separated from each other with only single prism or beam splitter. In an alternative embodiment, instead of using cavity mirror 505, a beam splitter (not shown) could be inserted on the left side of NLO crystal 160B2 to combine the fourth harmonic beam with the circulating second fundamental beam inside the resonant cavity. In another alternative embodiment, instead of using beam splitter 514, mirror 506 may have a dichroic coating to reflect the second harmonic beam while transmitting the CW output light and the unconsumed first SFG light.

In some embodiments one or more of the non-linear crystals utilized in SFG (frequency mixing) units 130B1 (FIG. 4) and 130B2 (FIG. 5) is/are implemented using an annealed (deuterium-treated or hydrogen-treated) cesium lithium borate (CLBO) crystal, where the annealed CLBO crystal is maintained at a constant temperature of approximately 80° C. or lower during operation of the laser assembly. In other embodiments, SFG units 130B1 and/or 130B2 may include a BBO, LBO or other non-linear crystal configured for frequency mixing (sum frequency generation).

The 193 nm CW laser assemblies of the present invention have several advantages compared with prior-art lasers. Compared with prior art lasers that generate 193 nm, the 193 nm laser assemblies of the present invention have the advantages of being CW, of having efficient frequency-conversion stages (due to the wavelengths used, the use of cavities to build up the power of the circulating light, and the properties of the nonlinear crystals), and of using two fundamental wavelengths that are readily available at power levels of tens of Watts or higher. The 193 nm CW laser assemblies may be scaled to output powers of 1 W or higher to enable the detection of smaller particles and defects. Furthermore, the overall laser system is more stable with lower noise than prior art lasers because among other reasons, the sum-frequency-generation cavity/cavities and the 1^{st} frequency-doubling cavity are resonant at IR wavelengths (i.e., wavelengths longer than about 1 μm) and are therefore not as sensitive to external disturbances such as vibration and air turbulence as cavities resonant at shorter wavelengths. The 2^{nd} frequency doubling cavity has a cavity resonant at a wavelength that is half that of the first fundamental light, which is a wavelength of approximately 0.5 μm, and so is also not overly sensitive to external disturbances. In the embodiments depicted in FIGS. 2B, 4 and 5, the first SFG process and second SFG process occur within a single resonant cavity that is only resonant for the second fundamental light.

The above description and associated figures illustrate various lasers for generating light having a wavelength of approximately 193 nm. Specific wavelengths and wavelength ranges are described in order to illustrate various embodiments. Other laser embodiments similar to those described above but generating a wavelength several nm shorter or longer than 193 nm are possible and are within the scope of this invention.

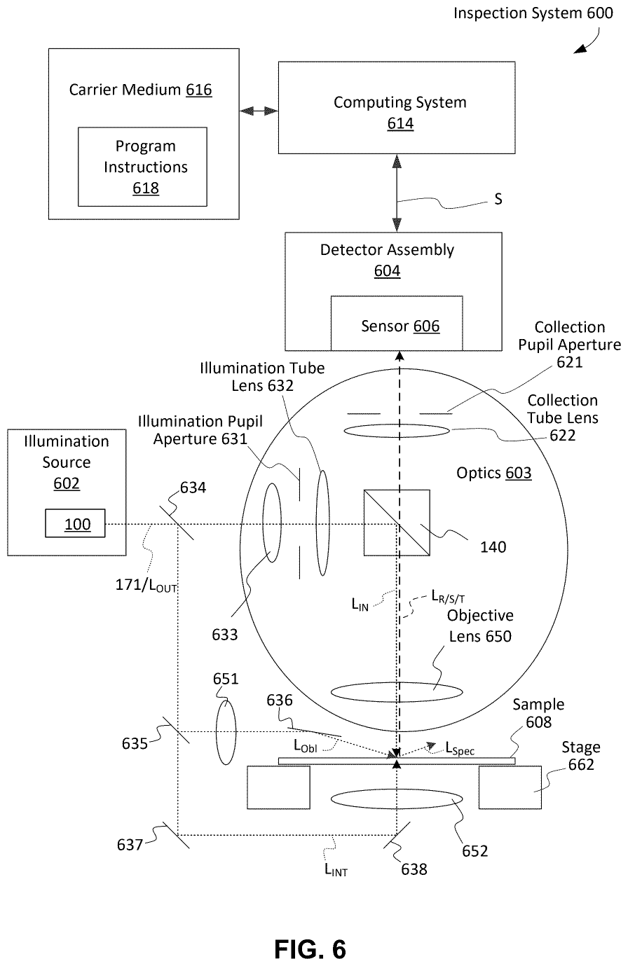

FIG. 6 shows an exemplary inspection system 600 configured to inspect or make measurements on a sample 608 using 193 nm CW output light 171 (L_{OUT}) generated by a CW laser assembly 100 in accordance with another embodiment of the present invention. Laser assembly 100 may be implemented using any of the laser assembly embodiments and variations described above. Inspection system 600 may be configured as an inspection system or a metrology system that inspects and/or makes measurements on sample 608. Inspection system 600 may also be configured to cut, drill or ablate material from sample 608, or to expose a pattern onto photoresist on sample 608.

Sample 608 may include any sample known in the art such as, but not limited to, a wafer, reticle, photomask, or the like. In one embodiment, the sample 608 may be disposed on a stage assembly 612 to facilitate movement of sample 608. Stage assembly 612 may include any stage assembly known in the art including, but not limited to, an X-Y stage, an R-θ stage, and the like. In another embodiment, stage assembly 612 is capable of adjusting the height of sample 608 during inspection to maintain focus on sample 608. In yet another embodiment, a lens such as objective lens 650 may be moved up and down during inspection to maintain focus on sample 608.

Inspection system 600 includes an illumination source 602 that incorporates a laser assembly 100 that generates CW output light 171/L_{OUT} at an output frequency with a corresponding a wavelength in a range between approximately 180 nm and approximately 200 nm, such as a wavelength near 193 nm, as disclosed herein. Illumination source 602 may include additional light sources such as a laser operating at a longer or shorter wavelength or a broadband light source. Inspection system 600 includes one or more optical components such as beam splitters, mirrors, lenses, apertures and waveplates that are configured to condition and direct CW output light 171/L_{OUT} to sample 608, and can be configured from one or more of strontium tetraborate, calcium fluoride, excimer-grade fused silica and other DUV-transmissive materials. The optical components may be configured to illuminate an area, a line, or a spot on sample 608. In one embodiment beam splitter or mirror 634, mirrors 637 and 638 and lens 652 are configured to illuminate sample 608 from below to enable inspection or measurement of sample 608 by transmitting light L_{INT} through the sample. In another embodiment, beam splitters or mirrors 634 and 635, mirror 636 and lens 651 are configured to illuminate sample 608 with light at an oblique angle of incidence L_{Obl}, for example at an angle of incidence greater than 60° relative to a normal to the sample surface. In this embodiment, the specularly reflected light L_{Spec} may be blocked or discarded rather than collected. In yet another embodiment, optics 603 are collectively configured to direct illumination light L_{IN} to the top surface of sample 608.

When sample 608 is illuminated in one or more of the above-described modes, optics 603 is also configured to collect light L_{R/S/T} reflected, scattered, diffracted, transmitted and/or emitted from sample 608, and direct and focus light L_{R/S/T} to sensor 606 of a detector assembly 604, whereby the collected light is converted to image data encoded in an electronic (e.g., digital or analog) signal S. It is noted herein that sensor 606 and detector assembly 604 may include any sensor 606 known in the art. The sensor may include, but is not limited to, a charge-coupled device (CCD) detector, a complementary metal oxide semiconductor (CMOS) detector, a time-delay integration (TDI) detector, a photomultiplier tube (PMT), an avalanche photodiode (APD), a line sensor, an electron-bombarded line sensor, or the like. Detector assembly 604 is communicatively coupled to a computing system 614, for example, such that image data may be transferred from sensor 604 to computing system 614 by way of signal S.

Computing system (controller) 614 is configured to store and/or analyze the image data contained in signal S that is received from detector assembly 604 under control of program instructions 618 stored on carrier medium 616. Computing system 614 may be further configured to control other elements of inspection system 600 such as stage 612, illumination source 602 and optics 603.

In one embodiment, optics 603 includes an illumination tube lens 632. The illumination tube lens 632 may be configured to image an illumination pupil aperture 631 to a pupil within an objective lens 650. For example, illumination tube lens 632 may be configured such that illumination pupil aperture 631 and the pupil within objective lens 650 are conjugate to one another. In one embodiment, illumination pupil aperture 631 may be configurable by switching different apertures into the location of illumination pupil aperture 631. In another embodiment, illumination pupil aperture 631 may be configurable by adjusting a diameter or shape of the opening of illumination pupil aperture 631. In this regard, sample 608 may be illuminated by different ranges of angles depending on the characterization (e.g., measurement or inspection) being performed under control of controller 614. Illumination pupil aperture 631 may also include a polarizing element to control the polarization state of illumination light L_{IN}.

In one embodiment, the one or more optical elements 603 include a collection tube lens 622. For example, collection tube lens 622 may be configured to image the pupil within the objective lens 650 to a collection pupil aperture 621. For instance, collection tube lens 622 may be configured such that collection pupil aperture 621 and the pupil within objective lens 650 are conjugate to one another. In one embodiment, collection pupil aperture 621 may be configurable by switching different apertures into the location of collection pupil aperture 621. In another embodiment, collection pupil aperture 621 may be configurable by adjusting a diameter or shape of the opening of collection pupil aperture 621. In this regard, different ranges of angles of illumination reflected or scattered from the sample 608 may be directed to detector assembly 604 under control of controller 614. Collection pupil aperture 621 may also include a polarizing element so that a specific polarization of light L_{R/S/T} can be selected for transmission to sensor 606. In another embodiment, illumination pupil aperture 631 and/or collection pupil aperture 621 may include a programmable aperture.

The various optical elements and operating modes depicted in FIG. 6 are merely to illustrate how CW laser assembly 100 may be used in inspection system 600 and are not intended to limit the scope of the present invention. A practical inspection system 600 may implement a subset or a superset of the modes and optics depicted in FIG. 6. Additional optical elements and subsystems may be incorporated as needed for a specific application.

One skilled in the appropriate arts will readily appreciate that there are many possible applications of the inventive laser assemblies and methods described herein in addition to their use in semiconductor inspection and metrology. For example, a laser assembly configured as described herein and operating at a wavelength close to 193.4 nm can be used in a lithography system configured to expose patterns into photoresist coated on a substrate such as a semiconductor wafer. Although the present invention has been described with respect to certain specific embodiments, it will be clear to those skilled in the art that the inventive features of the present invention are applicable to other embodiments as well, all of which are intended to fall within the scope of the present invention.

1. A laser assembly comprising:
a first laser light source configured to generate first continuous-wave (CW) light at a first power level and a first deep-ultraviolet (DUV) frequency having a first DUV wavelength in a range between 250 nm and 275 nm;
a second laser light source configured to generate second CW light at a second power level and an infrared (IR) frequency having an IR wavelength in a range between 1300 nm and 1700 nm;
at least one resonant cavity configured to enhance the second CW light received from the second laser light source such that the enhanced CW light has a third power level that is greater than the second power level;
a first non-linear optical (NLO) crystal configured to generate a sum-frequency generation (SFG) light at a second DUV frequency by mixing the first CW light and a first portion of the enhanced CW light; and
a second NLO crystal configured to generate CW output light at a third DUV frequency having a corresponding third DUV wavelength in a range between 180 nm and 200 nm by mixing the SFG light and a second portion of the enhanced CW light.

2. The laser assembly of claim 1, wherein the first laser light source comprises:
a first fundamental laser configured to generate first fundamental CW light at a first fundamental frequency having a corresponding first fundamental wavelength in a range between about 1010 nm and 1090 nm;
a first frequency doubling cavity configured to receive the first fundamental laser and to generate second harmonic light at a second harmonic frequency; and
a second frequency doubling cavity configured to receive the second harmonic light and to generate the first CW light at the first DUV frequency.

3. The laser assembly of claim 2, wherein the first fundamental laser comprises one of an ytterbium-doped yttrium aluminum garnet (Yb:YAG) lasing medium, a neodymium-doped yttrium aluminum garnet (Nd:YAG) lasing medium, a neodymium-doped yttrium orthovanadate (Nd:YVO₄) lasing medium, an ytterbium-doped fiber lasing medium, and a neodymium-doped yttrium lithium fluoride (Nd:YLF) lasing medium.

4. The laser assembly of claim 1, wherein the second laser light source comprises one of an erbium-doped yttrium aluminum garnet (Er:YAG) lasing medium, an erbium-doped fiber lasing medium, a neodymium-doped yttrium orthovanadate (Nd:YVO₄) lasing medium, and a Raman fiber lasing medium.

5. The laser assembly of claim 1,
wherein the first laser source comprises:
one of an ytterbium-doped yttrium aluminum garnet (Yb:YAG) lasing medium and an ytterbium-doped fiber lasing medium configured to generate first fundamental CW light at a first fundamental frequency having a corresponding first fundamental wavelength of approximately 1029 nm; and
a fourth harmonic generation module configured to receive the first fundamental CW light and to generate said first CW light at the first DUV frequency having a wavelength of approximately 257 nm, and
wherein the second laser light source comprises an erbium-doped fiber lasing medium configured to generate said second CW light at the IR frequency having a wavelength of approximately 1557 nm,
whereby said third DUV frequency of said CW output light has a wavelength of approximately 193.4 nm.

6. The laser assembly of claim 1,
wherein the first laser source comprises:
an ytterbium-doped fiber lasing medium configured to generate first fundamental CW light at a first fundamental frequency having a corresponding first fundamental wavelength of approximately 1087 nm; and
a fourth harmonic generation module configured to receive the first fundamental CW light and to generate said first CW light at the first DUV frequency having a wavelength of approximately 272 nm, and
wherein the second laser light source comprises a neodymium-doped yttrium orthovanadate (Nd:YVO₄) lasing medium configured to generate said second CW light at the IR frequency having a wavelength of approximately 1342 nm,
whereby said third DUV frequency of said CW output light has a wavelength of approximately 193.4 nm.

7. The laser assembly of claim 1, wherein said at least one resonant cavity comprises one of a bowtie cavity, a delta-shaped cavity and a standing-wave cavity.

8. The laser assembly of claim 1, wherein each of the first NLO crystal and the second NLO crystal comprises one of a cesium lithium borate (CLBO) crystal, a lithium triborate (LBO) crystal and a beta barium borate (BBO) crystal.

9. The laser assembly of claim 1, wherein said at least one resonant cavity includes:
a beam splitter configured to split the second CW light into a first CW portion and a second CW portion;
a first resonant cavity configured to receive said first CW portion of the second CW light and to generate said first portion of the enhanced CW light by circulating said enhanced CW light along a first closed optical path; and
a second resonant cavity configured to receive said second CW portion of the second CW light and to generate said second portion of the enhanced CW light by circulating said enhanced CW light along a second closed optical path.

10. The laser assembly of claim 9,
wherein the first resonant cavity comprises a plurality of optical elements that collectively form the first optical path,
wherein said first NLO crystal is positioned in the first closed optical path such that a first beam segment of the first portion of the enhanced CW light is directed from a first optical element of the plurality of optical elements onto an input surface of the first NLO crystal and an unconsumed beam segment of the enhanced CW light is directed from an output surface of the first NLO crystal to a second optical element of the plurality of optical elements, and
wherein the first NLO crystal is configured such that the input surface of the first NLO crystal is approximately at Brewster's angle relative to polarization of the first beam segment of the enhanced CW light.

11. The laser assembly of claim 10, wherein the first CW light is directed onto the input surface of the first NLO crystal at a first deviated angle relative to the first beam segment of the enhanced CW light such that the first CW light and the first beam segment of the enhanced CW light are substantially overlapped inside the first NLO crystal, and wherein the deviated angle is less than 10°.

12. The laser assembly of claim 1,
wherein said at least one resonant cavity is configured to circulate said enhanced CW light along a closed optical path,
wherein the first NLO crystal and the second NLO crystal are positioned in the closed optical path such that the first NLO crystal receives the first portion of the enhanced CW light and the second NLO crystal receives the second portion of the enhanced CW light, and
wherein said at least one resonant cavity is further configured such that the SFG light generated by the first NLO crystal is directed to the second NLO crystal.

13. The laser assembly of claim 12, wherein said at least one resonant cavity includes a plurality of first optical elements configured to circulate said enhanced CW light along the closed optical path such that the first beam segment of the enhanced CW light is directed along a first segment of the optical path from a first optical element of the plurality of first optical elements to an input surface of the first NLO crystal and a first unconsumed beam segment of the enhanced CW light is directed along a second segment of the optical path from an output surface of the first NLO crystal to a second optical element of the plurality of first optical elements, and such that the second portion of the enhanced CW light is directed along a third segment of the optical path from a third optical element of the plurality of first optical elements to an input surface of the second NLO crystal and a second unconsumed portion of the enhanced CW light is directed along a fourth segment of the optical path from an output surface of the second NLO crystal to a fourth optical element of the plurality of first optical elements.

14. The laser assembly of claim 13,
wherein the first NLO crystal is configured such that the input surface of the first NLO crystal is approximately at Brewster's angle relative to polarization of the first beam segment of the enhanced CW light, and
wherein the first CW light is directed onto the input surface of the first NLO crystal at a first deviated angle relative to the first beam segment of the enhanced CW light, and wherein the first deviated angle is less than 10°.

15. The laser assembly of claim 14,
wherein said at least one resonant cavity further includes a plurality of second optical elements configured to direct the SFG light from the output surface of the first NLO crystal to the input surface of the second NLO crystal,
wherein the second NLO crystal is configured such that the input surface of the second NLO crystal is approximately at Brewster's angle relative to polarization of the second portion of the enhanced CW light, and
wherein the SFG light is directed by the plurality of second optical elements onto the input surface of the first NLO crystal at a second deviated angle relative to the second portion of the enhanced CW light, and
wherein the second deviated angle is less than 10°.

16. The laser assembly of claim 15, further comprising a plurality of fifth optical elements configured to focus the first CW light, the second CW light and the SFG light such that a first beam waist of the first CW light is focused inside the first NLO crystal, and such that both a second beam waist of the second CW light and a third beam waist of the SFG light are focused inside the second NLO crystal.

17. A method comprising:
generating first continuous-wave (CW) light at a first power level having a deep-ultraviolet (DUV) wavelength in a range between 250 nm and 275 nm;
generating second CW light at a second power level having an infrared (IR) wavelength in a range between 1300 nm and 1700 nm; and
enhancing the second CW light to produce enhanced CW light having the IR wavelength and a third power level that is greater than the second power level;
mixing the first CW light and a first portion of the enhanced CW light to generate sum-frequency generation (SFG) light; and
mixing the SFG light and a second portion of the enhanced CW light to generate CW output light having an output wavelength in a range between 180 nm and 200 nm.

18. The method of claim 17, wherein generating the first CW light comprises:
generating first fundamental CW light at a first fundamental wavelength in a range between 1010 nm and 1090 nm; and
generating a fourth harmonic of the first fundamental light, thereby producing said first CW light having the DUV wavelength.

19. The method of claim 17, wherein enhancing the second CW light comprises utilizing one of a bowtie resonant cavity, a delta-shaped resonant cavity and a standing-wave resonant cavity.

20. An inspection system configured to inspect a sample, the inspection system comprising:
a laser assembly configured to generate continuous-wave (CW) output light;
first optics configured to direct the CW output light from the laser assembly to the sample;
second optics configured to collect light from the sample;
a detector configured to convert the collected light into a corresponding signal; and
a computer system configured to analyze the signal,
wherein the laser assembly comprises:
a first laser light source configured to generate first CW light at a first power level and a first deep-ultraviolet (DUV) frequency having a first DUV wavelength in a range between 250 nm and 275 nm;
a second laser light source configured to generate second CW light at a second power level and an infrared (IR) frequency having an IR wavelength in a range between 1300 nm and 1700 nm;
at least one resonant cavity configured to enhance the second CW light received from the second laser light source such that the enhanced CW light has a third power level that is greater than the second power level;
a first non-linear optical (NLO) crystal configured to generate a sum-frequency generation (SFG) light at a second DUV frequency by mixing the first CW light and a first portion of the enhanced CW light; and
a second NLO crystal configured to generate said CW output light at a third DUV frequency having a corresponding third DUV wavelength in a range between 180 nm and 200 nm by mixing the SFG light and a second portion of the enhanced CW light.
